(19) United States
(12) Patent Application Publication
(10) Pub. No.: US 2025/0017368 A1
(43) Pub. Date: Jan. 16, 2025

(54) SMART CABINET

(71) Applicant: CLiCS, LLC, San Diego, CA (US)

(72) Inventors: Jeffrey F. MACEDO, Sparks, NV (US); Christopher MUNZ, Reno, NV (US); Jeffrey S. PLOETNER, San Diego, CA (US); Charles D. BROWN, San Diego, CA (US); Leilani M. MACEDO, La Jolla, CA (US)

(21) Appl. No.: 18/759,246

(22) Filed: Jun. 28, 2024

Related U.S. Application Data
(60) Provisional application No. 63/513,414, filed on Jul. 13, 2023.

(51) Int. Cl. A47B 81/00; A45D 19/00

(52) U.S. Cl. CPC A47B 81/00; A45D 19/0066; A47B 2210/07

(57) ABSTRACT

Embodiments relate to a dispensing system, such as a hair care product dispensing system, which controls access to an electronically controlled cabinet. In some embodiments the dispensing system tracks the inventory of the items stored in the cabinet.

### INCORPORATION BY REFERENCE TO PRIORITY APPLICATION

This application claims the benefit of U.S. Provisional Application No. 63/513,414, filed Jul. 13, 2023, which is hereby incorporated by reference in its entirety.

### BACKGROUND

Electronically controlled hair dye dispensing systems are becoming increasingly popular in the hair salon industry and allow for mechanized distribution and mixing of hair dyes. The components that are used to create hair coloring compositions are generally distributed separately in containers such as tubes, canisters, or bottles and allow a stylist to create custom hair dye blends for their clients. Hair stylists need to track and store these containers in order to determine inventory and prevent shrinkage and opportunity for theft.

### SUMMARY OF THE INVENTION

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, a smart storage cabinet for holding product canisters is provided. The smart storage cabinet includes a main door which provides access to a main compartment, where the main door has a striker; a striker receiver which receives the striker when the door is in a closed position, where the striker receiver includes a lock and a sensor which communicate with a dispenser and are configured to determine if the door is open or closed; one or more canister drawers slidably coupled with the main compartment, where the one or more slidable drawers feature a plurality of slots for holding product canisters; a secondary drawer slidably coupled with a secondary compartment; and an inventory scanner for tracking the number of canisters present within each drawer and the contents of each canister.

In some embodiments, access to the cabinet is limited to users who have access to the dispenser. In some embodiments, the cabinet includes two canister drawers where each of the drawers holds 56 canisters in a custom sized grid. In some embodiments, the custom sized grid is detachable for cleaning. In some embodiments, the cabinet further includes a second inventory scanner disposed on a lower surface of a first canister drawer and configured to scan canisters of a second canister drawer upon loading and removal from the second canister drawer. In some embodiments, the cabinet includes wheels and wheel locks. In some embodiments, the cabinet further includes a tip prevention safety feature that prevents more than one drawer from being extended at a time. In some embodiments, the inventory scanner is integrated into the main compartment and is configured to scan canisters upon loading or removal from the one or more drawers. In some embodiments, the inventory scanner is a camera, RFID sensor or BAR code scanner. In some embodiments, the camera is configured to determine the contents of the one or more slidable drawers. In some embodiments, the canisters are equipped with a tag which contains information on the canister and the contents of the canister. In some embodiments, the tag includes one of an RFID tag, BAR code, or color code. In some embodiments, the tag is located on a cap of the canister. In some embodiments, the inventory scanner is a handheld scanner. In some embodiments, the cabinet further includes a pressure sensor within each of the plurality of slots of the drawers, wherein the pressure sensor is configured to track how many slots are occupied. In some embodiments, the cabinet communicates wirelessly with the dispenser.

### BRIEF DESCRIPTION OF THE DRAWINGS

FIG. 1 is a perspective view of a smart storage cabinet in communication with a dispensing system, according to some embodiments.

FIG. 2 is a perspective view of the smart storage cabinet without the dispensing system, according to some embodiments.

FIG. 3 is a front view of the smart storage cabinet with a main door open and a secondary drawer closed, according to some embodiments.

FIG. 4 is a perspective view of an embodiment of a drawer locking mechanism, according to some embodiments.

FIG. 5A is a perspective view of a lock striker uncoupled from the main door, according to some embodiments.

FIG. 5B is a perspective view of a striker receiver which is located in an aperture of a contact surface of the cabinet, according to some embodiments.

FIG. 6A is a perspective view of the secondary drawer, according to some embodiments.

FIG. 6B is to top-down view of the secondary drawer, according to some embodiments.

FIG. 7A is a perspective view of a slidable drawer, according to some embodiments.

FIG. 7B is a top view of the slidable drawer, according to some embodiments.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

Embodiments relate to dispensing systems which control access to an electronically controlled cabinet. In some embodiments the dispensing system tracks the inventory of the canisters stored in the cabinet. Users of dispensing systems, such as salon owners, may keep and manage a large inventory of canisters which contain products, such as dye, developer, or other hair care or beauty products. Canisters may become misplaced, lost, or stolen due to the sheer number of canisters that are used on a daily basis, the fast-paced nature of salons, and the flow of traffic into and out of a salon. This results in time spent locating and tracking inventory which translates to a loss in hair stylist efficiency as canisters are not readily available when needed. Further still the profit margins of salon owners may be reduced as products are lost and/or stolen. Embodiments herein relate to solving these problems.

In one embodiment, a storage cabinet is accessed and controlled via a dispensing system. The system may provide access to authorized users only thus protecting the canisters or product within. Sensors may be placed within the cabinet to track the inventory therein and associate any inventory discrepancies with the user who accessed the cabinet to remove the product or canister. Furthermore, the system may track the use of the canister to determine the quantity of product remaining in each individual canister. The system may thus track product quantity of each canister within the cabinet and inform a user of total canister inventory and total product inventory. The described embodiments herein provide a simple and efficient way to track salon inventory of specific products while also reducing the possibility of misplaced canisters and theft.

The dye dispensing apparatus, system and method may monitor the individual canisters and transmit actual dispensed amounts to the network or central server (e.g., a cloud-based application, a standalone server device, etc.) which, in turn, may automate inventory management by initiating automated direct replenishment shipments of the canisters. The dye dispensing system may be operated by stylists using control panels or applications on mobile devices such as a laptop, tablet, smartphone or Web browser. Commands may be transmitted to the system from software operating on an online server or from the central server, or via an identifier (e.g. an RFID, BAR code, QR code or equivalents) which may be displayed on the smartphone and read by a scanner in the system.

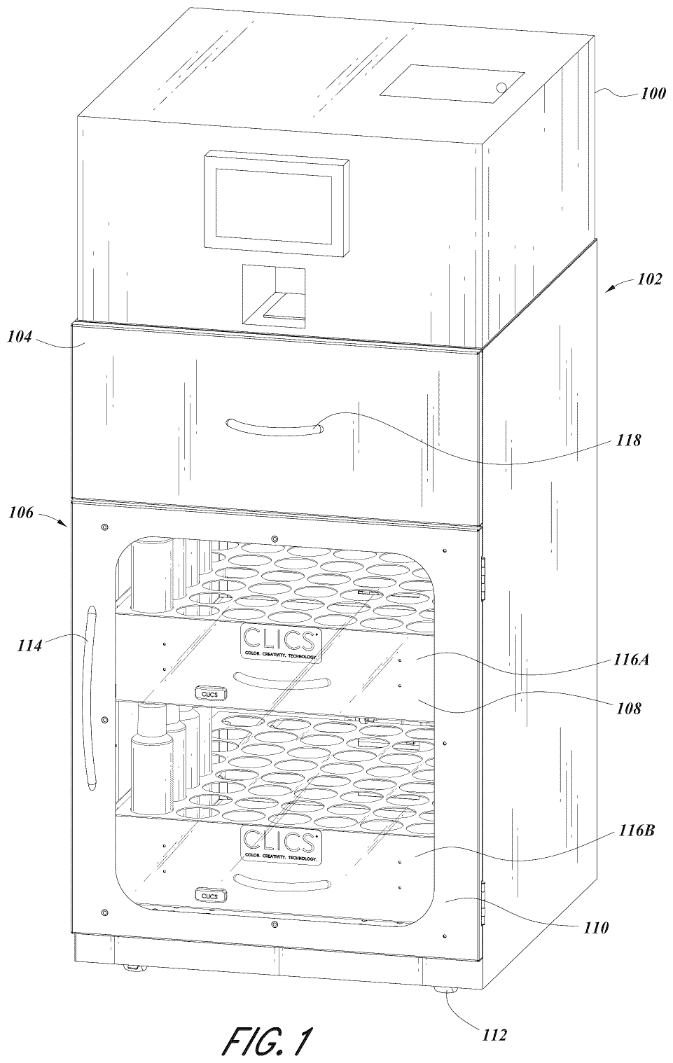

FIG. 1 is a perspective view of a smart storage cabinet 102 in communication with a dispensing system 100. The dispensing system 100 may be used to dispense a product, such as a dye or other fluid, to a user. In some embodiments, the dispensing system 100 is for dispensing fluids from canisters which are inserted into the dispensing system 100. A user may interact with the dispensing system 100 directly through an interface on the dispensing system 100 or through a user device such as a phone, laptop, or computer. The dispensing system 100 is shown as sitting directly on top of the smart storage cabinet 102. In some embodiments, the dispensing system 100 may be positioned separate and apart from the smart storage cabinet 102. In some embodiments, the dispensing system 100 may be fixed to the smart storage cabinet 102. In some embodiments, the dispensing system 100 may be electronically connected to the smart storage cabinet 102. In some embodiments, the dispensing system 100 may communicate wirelessly with the smart storage cabinet 102.

The smart storage cabinet 102 can take the general shape of a rectangular prism as shown in FIG. 1 but is not limited to such a shape. In some embodiments, the shape may resemble a cube, pyramid, or any other polygonal shape that is suitable and may include the below-described features.

The smart storage cabinet 102 has two compartments that allow access to inside the cabinet. A main compartment is accessible via a main door 106 which may be pivotally attached to the housing of the smart storage cabinet 102. In some embodiments, the main door 106 may be slidably attached. The main door 106 features an outer panel 110 that is made of a solid material and a center panel 108 that is made of a translucent material. The main door 106 can have a door handle 114 which is attached to either the outer or inner panel of the main door 106.

The main compartment may contain one or more canister drawers 116A,B which may contain the product to be dispensed from the dispensing system 100. In some embodiments, the product may be contained in canisters. These canisters may include hair care products such as dyes, developers, gels, conditioners, etc. These drawers are accessible by opening the main door 106 and are slidably disposed within the main compartment.

A secondary compartment may be accessible via a secondary drawer 104. The secondary drawer 104 may be optionally located above or below the main compartment. The secondary drawer 104 may feature a handle 118. The secondary drawer 104 may further be slidably disposed within the secondary compartment. The secondary drawer 104 may be used to store canisters or tools and/or devices of the dispensing system 100. In some embodiments where the dispensing system 100 is used to dispense hair dye, the secondary drawer 104 may be used to store hair products or salon equipment.

The smart storage cabinet 102 may additionally feature one or more wheels 112 that are attached to the underside of the smart storage cabinet 102. The one or more wheels 112 may allow for case of movement of the smart storage cabinet 102. The one or more wheels 112 may also feature a locking mechanism to prevent movement of the cabinet.

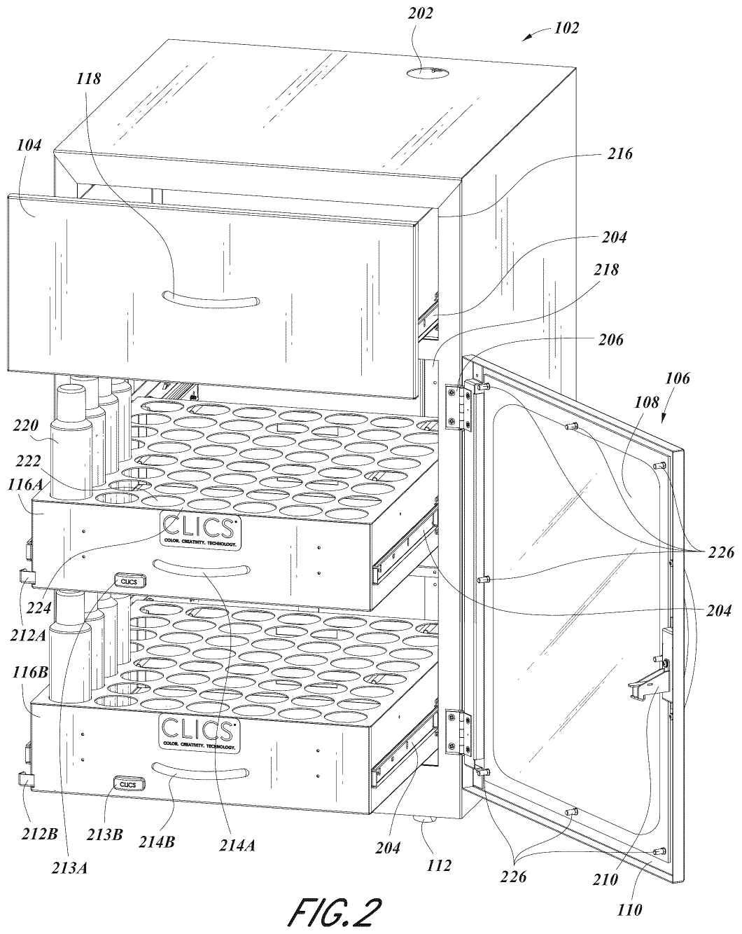

FIG. 2 is a perspective view of the smart storage cabinet 102 without the dispensing system 100. As shown, the main door 106 and secondary drawer 104 are open and the canister drawers 116A,B are extended.

An inlet 202 may optionally be disposed on an outer surface of the smart storage cabinet 102. While depicted on the top surface, this inlet 202 may be located on any surface of the smart storage cabinet 102. The inlet 202 may be used when the dispensing system 100 is electrically connected to the smart storage cabinet 102 and may accommodate cables that are attached to the dispensing system 100. Such wires may connect with other electronics within the smart storage cabinet 102 such as a door lock, sensor, and/or optical scanner. Additionally, a power cord for powering the smart storage cabinet 102 may be inserted into the inlet 202.

As shown, when the handle 118 is pulled the secondary drawer 104 opens by sliding on a pair of runners 204 disposed on opposing sides of the secondary drawer 104. Further, when the door handle 114 is pulled the main door 106 opens to allow access to a main compartment 218. In some embodiments, the main door 106 is attached to the smart storage cabinet 102 housing by one or more hinges 206. Specifically, the one or more hinges 206 which may be attached to the center panel 108 or outer panel 110 of the main door 106. In some embodiments, the main door 106 may include a lock striker 210 and a striker receiver which may notify the dispensing system 100 when the main door 106 is opened or closed.

The main compartment 218 may contain the one or more canister drawers 116A,B. The one or more canister drawers 116A,B may be slidably disposed within the main compartment 218. In some embodiments, the one or more canister drawers 116A,B may each feature a pair of runners 204 disposed on opposite sides of each drawer. Further, in some embodiments, the one or more canister drawers 116A,B may each have a cover 224 which is disposed over the top of each drawer. The cover 224 may have a plurality of slots 222 which accommodate an item or product to be used in the dispensing system 100. In some embodiments, the slots 222 may accommodate one or more canisters 220 that may be used in the dispensing system 100. Further, the one or more canister drawers 116A,B may include a tab 212A,B located on each drawer. These tabs 212A,B may be used to notify the dispensing system 100 when each of the one or more canister drawers 116A,B has been opened or closed. The one or more canister drawers 116A,B may also include one or more thumb latches 213A,B disposed on a front surface and positioned below the one or more handles 214A,B. According to some embodiments, the one or more canister drawers 116A,B are locked in place when closed. A user may actuate the one or more thumb latches 213A,B to open the one or more canister drawers 116A,B.

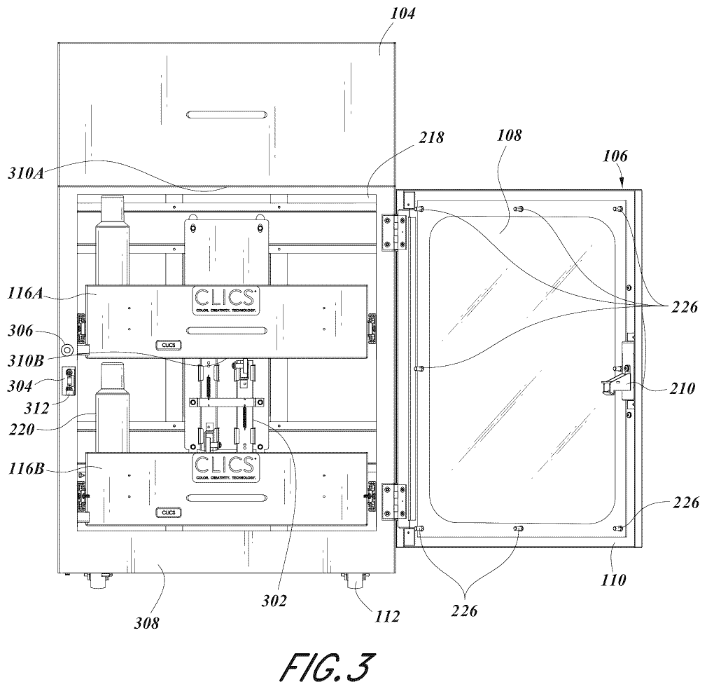

FIG. 3 is a front view of the smart storage cabinet 102 with the main door 106 open and the secondary drawer 104 closed.

As shown, the lock striker 210 extends from an inside surface of the main door 106 which, in some embodiments, may be the outer panel 110 which surrounds the center panel 108. A contact surface 308 borders the main compartment 218 and contacts the main door 106, or one or more spacers 226 extending from the main door 106, when the main door 106 is in a closed state. In some embodiments, the main door 106 may form a seal with the contact surface 308. An aperture 304 is located in the contact surface 308 and is positioned such to receive the lock striker 210 when the main door 106 is closed. A striker receiver 312 may be disposed within the aperture 304. The striker receiver 312 is configured to receive the lock striker 210 when the main door 106 is closed. Upon receiving the lock striker 210 the striker receiver 312 and lock striker 210 may interact to lock the main door 106 in a closed state.

In some embodiments, the striker receiver 312 may sense when the main door 106 is in an opened or closed state. The lock striker 210 may communicate with the striker receiver 312 such that the striker receiver 312 and lock striker 210 will lock the main door 106 upon sensing that the main door 106 is in a closed positioned or when instructed by the dispensing system 100.

In some embodiments, a door stop 306 may be located on the contact surface 308. The door stop 306 may be spring-loaded such that when the door is unlocked, the door springs open automatically.

As shown in FIG. 3, the one or more canister drawers 116A,B are located in the main compartment 218 in a closed or unextended position. Located on a back wall of the main compartment 218 is a drawer locking mechanism 302. This mechanism may prevent more than one of the canister drawers 116A,B from being extended at the same time. For example, when canister drawer 116A is extended, drawer 116B may not be extended and vice versa. Further, when both drawers are unextended, either 116A or 116B, but not both, may be extended. This drawer locking mechanism 302 prevents both drawers from being extended at the same time in order to minimize the risk of the smart storage cabinet 102 becoming unbalanced and falling forward.

In some embodiments, a scanner 310A may be used to detect inventory of the main compartment 218 and convey information regarding the inventory to the dispensing system 100. As described herein, this inventory may include canisters 220 or other product containers. In some embodiments, the canisters 220 may have identifiers that can be read by the scanner 310A. Furthermore, in some embodiments, the identifier on the canister 220 may be associated with the contents of each canister. The scanner 310A may include one or more of an RFID sensor, BAR code scanner, or camera.

In some embodiments, the scanner 310A may be located on a top inside surface of the main compartment 218. In some embodiments, the scanner 310A may be positioned such that it can detect each canister of the slidable drawer 116A. In some embodiments including a second slidable drawer 116B, a second scanner 310B may be used. In some embodiments, the second scanner 310B may be positioned on a lower surface of the slidable drawer 116A. Thus, in some embodiments a plurality of scanners (e.g. 310A and 310B) may be used to detect the contents of the associated slidable drawers (e.g. 116A and 116B) such that the dispensing system 100 may determine, in real-time, the presence and contents of each canister 220 of the main compartment 218.

In some embodiments, the scanner is a handheld scanner that is removably located inside the main compartment 218 or alternatively on the outside of the smart storage cabinet 102. In some embodiments, the handheld scanner may be a tablet or mobile device. In some embodiments, a user may use the handheld scanner to physically scan each canister 220 after removal from the smart storage cabinet 102.

In an example embodiment, a user may sign into the dispensing system 100 to unlock the main door 106 and remove one or more canisters from the smart storage cabinet 102. The scanner may then determine which canisters 220 were removed and associate those canisters with the user who unlocked the door. This may allow inventory tracking and use and may help to prevent theft of the canisters.

In some embodiments the user may take the removed canisters and insert them into the dispensing system 100 to dispense a product, such as dye, from the canister. The dispensing system 100 may then track the amount of product that was dispensed and associate the amount dispensed with the specific canister 220 and record this in a database. The user may then put the canisters 220 back into the smart storage cabinet 102. The user may then access the dispensing system 100 to determine the number of canisters in the smart storage cabinet 102, the contents of each canister 220, and the amount of product left within each canister 220.

The smart storage cabinet 102 may control access to the inventory held within thus reducing shrinkage and theft.

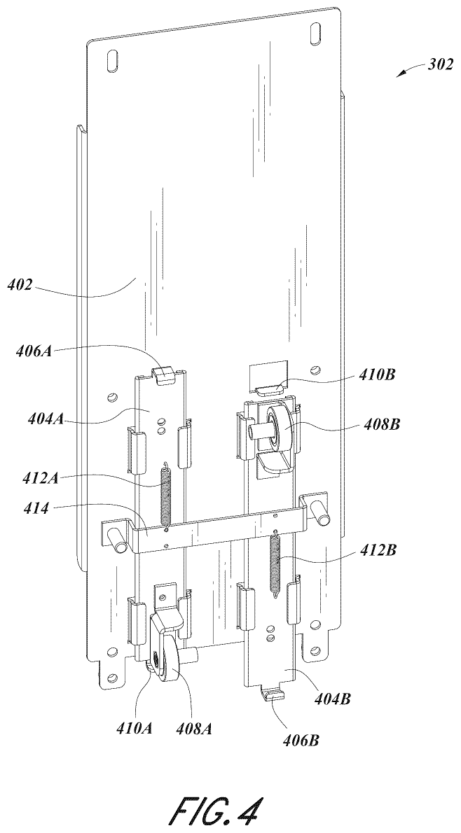

FIG. 4 is a perspective view of an embodiment of the drawer locking mechanism 302. The drawer locking mechanism 302 may have a back plate 402 which is coupled in the back wall of the main compartment 218. A first lock bar 404A and a second lock bar 404B may be slidably coupled to the back plate 402. The first and second lock bars 404A,B may be rectangular in shape and extend vertically along the back plate 402. An anchor 414 may be coupled to the back plate 402 and extend perpendicular the lock bars. The anchor 414 may be positioned such that the lock bars 404A,B are positioned between the anchor 414 and back plate 402. Each lock bar 404A,B may be attached to the anchor 414 by a spring. For example, first lock bar 404A may be attached to anchor 414 by spring 412A while second lock bar 404B may be attached to anchor 414 by spring 412B.

Each of the lock bars 404A,B may have a latch 406A,B that extends from an end of the lock bars 404A,B. Each of lock bars 404A,B may also have a clip 410A,B that extends from an opposite end. Each lock bar 404A,B may also have a wheel 408A,B that is positioned adjacent the clip 410A,B. As shown, the orientation of first lock bar 404A may be inverse the orientation of second lock bar 404B such that the latch 406A of first lock bar 404A extends in the opposite direction as the latch 406B of second lock bar 404B. As such, the spring 412B, wheel 408B, and clip 410B of second lock bar 404B will also be positioned opposite the spring 412A, wheel 408A, and clip of first lock bar 404A.

Each of the lock bars 404A,B may interact with a drawer positioned above and below the drawer locking mechanism 302, for example, drawer 116A and drawer 116B of FIG. 2. The drawer locking mechanism 302 may mechanically prevent both drawers from being opened at the same time. For example, drawer 116A must be closed before drawer 116B can be opened and vice versa. When drawer 116A is closed, it activates lock bar 404B and unlocks the latch 406B, allowing drawer 116B to be opened. If drawer 116A is not pushed all the way in, then lock bar 404B causes latch 406B to lock drawer 116B in place, preventing it from opening. By preventing both drawers from opening at the same time the smart storage cabinet 102 has a greater likelihood of not becoming unbalanced and falling forward.

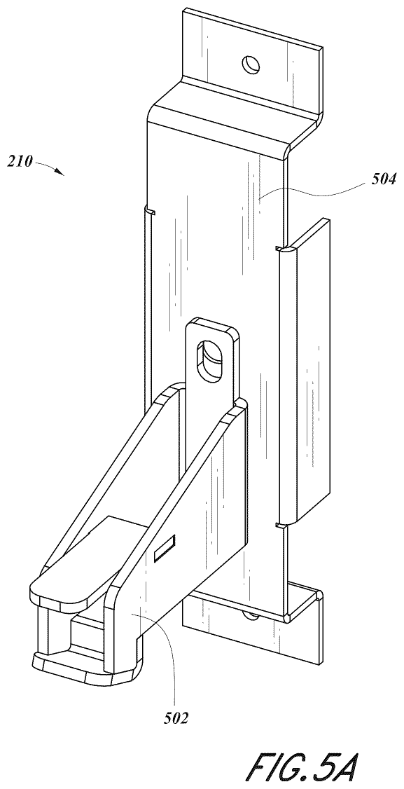

FIG. 5A is a perspective view of the lock striker 210 uncoupled from the main door. Here the lock striker 210 includes an elongated latch 502 and a bracket 504 that are coupled together. The bracket 504 may be secured to the main door by one or more screws. The elongated latch 502 extends from the bracket 504 in an elongated manner. FIG. 5B is a perspective view of the striker receiver 312 which is located in an aperture of a contact surface of the cabinet. The striker receiver 312 is secured within the aperture by a bracket 506. The striker receiver 312 includes a lock sensor 508, a latch 512, and an electronic motor 510. The striker receiver 312 is electronically connected to the smart cabinet and communicates with the dispensing system.

When the main door 106 is positioned in a closed position, the lock striker 210 enters the aperture and contacts the lock sensor 508 which notifies the dispensing system that the door is in a closed position. The system may then instruct the electronic motor 510 to extend the latch 512 in a vertical direction thus engaging the lock striker 210. The system may do this automatically or by user instruction. To unlock the main door 106 a user may access the dispensing system and enter a command to unlock the door. The system may then process this command and instruct the electronic motor 510 to retract the latch 512. Thus, access to the smart storage cabinet may be limited to users who have access to the dispensing system.

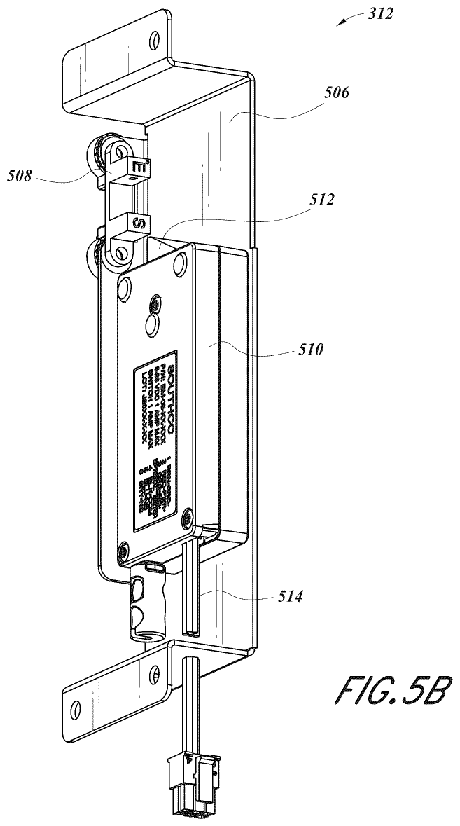

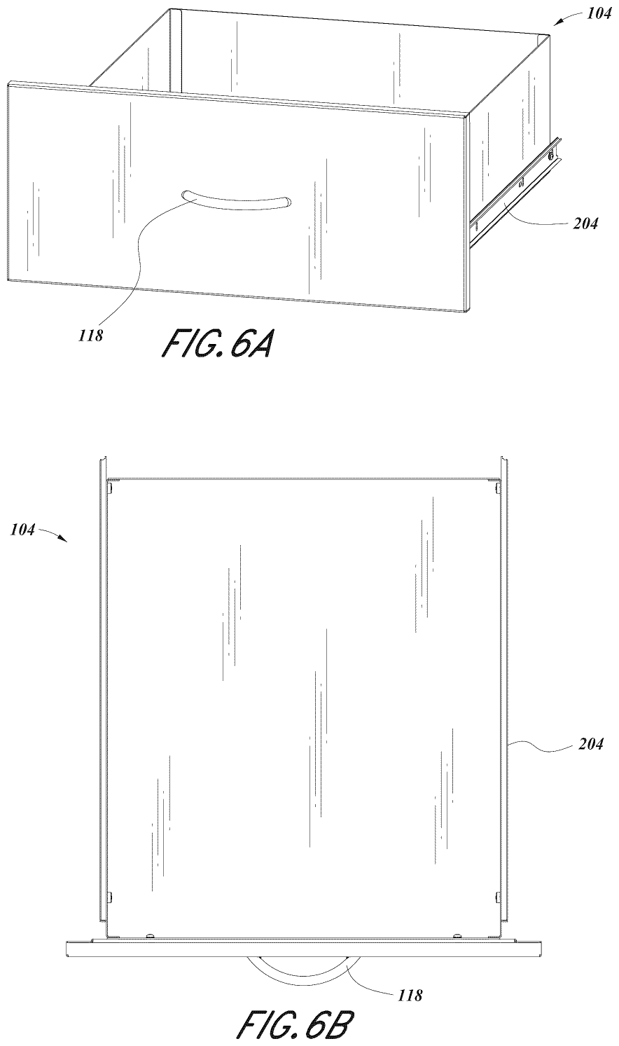

FIG. 6A is a perspective view of the secondary drawer 104. FIG. 6B is to top-down view of the secondary drawer 104. In some embodiments, the overall shape of the secondary drawer 104 may match the shape of the secondary compartment. In some embodiments, this shape may be a rectangular prism. The secondary drawer 104 may feature a front panel with a door handle 118 by which a user may open and close the secondary drawer 104. Further, the secondary drawer 104 may include a pair of runners 204, one on each side of the drawer, which allow the secondary drawer 104 to slide from an opened to closed position. The runners 204 are coupled with slides that are positioned inside the secondary compartment.

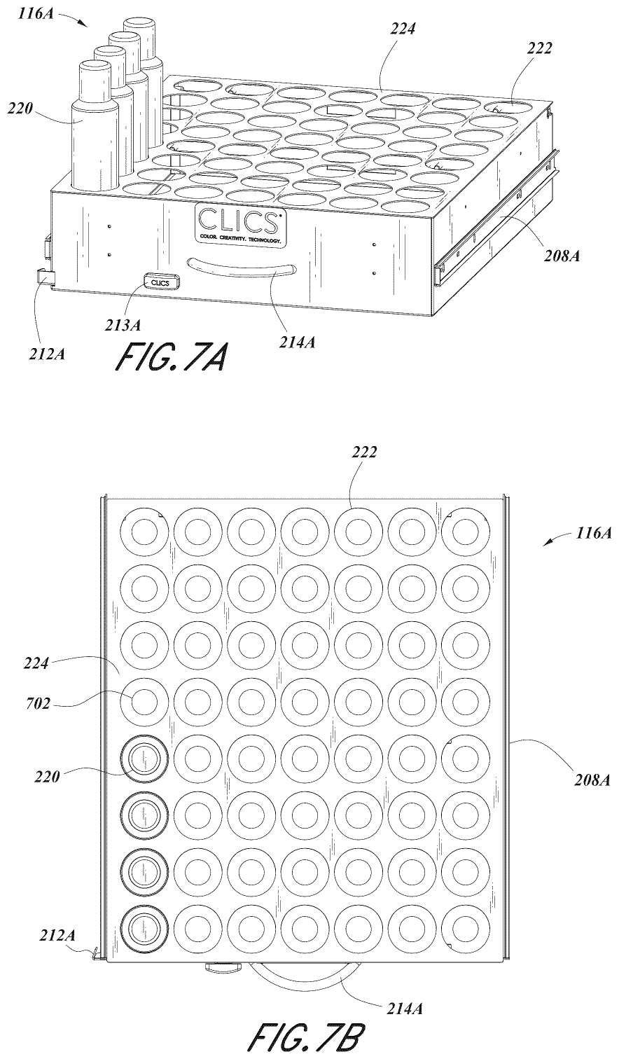

FIG. 7A is a perspective view of slidable drawer 116A. FIG. 7B is a top view of a slidable drawer 116A. As disclosed herein, the below description of slidable drawer 116A may also describe a second slidable drawer, such as drawer 116B as discussed in previous figure descriptions.

Slidable drawer 116A may resemble a rectangular prism as depicted in the figures. In some embodiments, slidable drawer 116A may have a handle 214A on a front panel which allows a user to open and close the drawer. Further, a pair of runners 208A may be disposed on opposite sides of the slidable drawer 116A. The runners 208A may be coupled to slides disposed on the inside surface of the main compartment 218. The runners 208A allow the slidable drawer 116A to slide into an opened and closed position. In some embodiments, the slidable drawer 116A may feature a tab 212A which is disposed on the front panel. The tab 212A may extend parallel the front panel and hook at the end such that the tab 212A has an L shape or a slightly acute angle to help lead it in when closing the drawer. The tab 212A can additionally function to lock drawer 116A in place to prevent it from opening until the thumb latch 213A, which is connected to 212A, is actuated to release the tab 212A from the closed position and allow the drawer 116A to open. When the slidable drawer 116A is in a closed position, the tab 212A may contact a sensor which notifies the dispensing system 100 that the slidable drawer 116A is closed.

The slidable drawer 116A may have a cover 224 with a plurality of slots 222 which make up a custom sized grid. In some embodiments, the slots 222 may be shaped as a circle and may accommodate a canister 220. As shown, four canisters 220 are positioned within four slots 222 of the fifty-six total slots. In some embodiments, the number of slots 222 may be higher or lower depending on the size of the drawer 116A and size of the canisters 220. In some embodiments, there is no cover 224. In some embodiments, the cover 224 may be optionally removable which allow a user to clean and/or replace the cover.

As disclosed herein, one or more sensors may be positioned within the main compartment of the cabinet which communicate with the system. In some embodiments, the sensor may determine whether a particular slot 222 is empty or if it has a canister 220. In some embodiments, each canister 220 has an identifier that is associated with the canister 220 and/or the contents of the canister 220. In some embodiments, this may include an image or color disposed on the canister or a canister cap. In some embodiments, the identifier may be a tag such as an RFID tag, a BAR code, or a color code. Thus, in some embodiments, the system may be able to determine the number of canisters present within the cabinet, the location of each canister, and the contents of each canister.

In some embodiments, the slidable drawer 116A may have one or more proximity sensors 702 or pressure sensors disposed on a bottom surface of the drawer. In some embodiments, each of the one or more proximity sensors 702 may be centered within each slot 222 of the cover 224. The one or more one or more proximity sensors 702 may determine the presence or absence of canisters 220 within each slot 222. Thus, the system may track the number and relative location of canisters within the smart storage cabinet 102 based on the signal received from the one or more proximity sensors 702.

According to some embodiments, the smart storage cabinet 102 is electrically connected to the dispensing system 100. The various smart features of the smart storage cabinet 102, i.e. the lock striker 210/striker receiver 312, scanners 310A,B, sensors which interact with tabs 212A,B, and the one or more proximity sensors 702, may receive power from the dispensing system 100. Further, each of these smart features may communicate directly with the dispensing system 100 via one or more electrical connections. According to some embodiments, the smart storage cabinet 102 includes a power cord which connects to an external power source. According to some embodiments, the smart storage cabinet 102 includes an internal power source such as a battery or capacitor. According to some embodiments, the smart storage cabinet 102 communicates wirelessly with the dispensing system 100. This wireless communication may include one or more of RFID, WiFi, Bluetooth, near field communication (NFC) or cellular communication. In some embodiments, the smart storage cabinet 102 communicates wirelessly with a mobile device. According to some embodiments, each smart feature may be configured with a wireless receiver/transmitter. According to some embodiments, each smart feature is connected to a controller within the smart storage cabinet 102. The controller may communicate with the dispensing system 100 or mobile device via a receiver/transmitter. The controller may be a microcontroller.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A smart storage cabinet for holding product canisters comprising:
a main door which provides access to a main compartment, wherein the main door has a striker;
a striker receiver which receives the striker when the door is in a closed position, wherein the striker receiver is comprised of a lock and a sensor which communicate with a dispenser and are configured to determine if the door is open or closed;
one or more canister drawers slidably coupled with the main compartment, wherein the one or more slidable drawers comprise a plurality of slots for holding product canisters;
a secondary drawer slidably coupled with a secondary compartment; and
an inventory scanner configured to track the number of canisters present within each drawer and the contents of each canister.

2. The smart cabinet of claim 1, wherein the access to the cabinet is limited to users who have access to the dispenser.

3. The smart cabinet of claim 1, having two canister drawers wherein each of the slidable drawers holds 56 canisters in a grid.

4. The smart cabinet of claim 3, wherein the grid is detachable for cleaning.

5. The smart cabinet of claim 3, further comprising a second inventory scanner disposed on a lower surface of a first canister drawer and configured to scan canisters of a second canister drawer upon loading and removal from the second canister drawer.

6. The smart cabinet of claim 1, further comprising wheels and wheel locks.

7. The smart cabinet of claim 1, further comprising a tip prevention safety feature that prevents more than one drawer from being extended at a time.

8. The smart cabinet of claim 1, wherein the inventory scanner is integrated into the main compartment and is configured to scan canisters upon loading or removal of canisters from the one or more drawers.

9. The smart cabinet of claim 1, wherein the inventory scanner is a camera, RFID sensor or BAR code scanner.

10. The smart cabinet of claim 9, wherein the camera is configured to determine the contents of the one or more slidable drawers.

11. The smart cabinet of claim 1, wherein the canisters are equipped with a tag which contains information on the canister and the contents of the canister.

12. The smart cabinet of claim 11, wherein the tag comprises one of an RFID tag, BAR code, or color code.

13. The smart cabinet of claim 11, wherein the tag is located on a cap of the canister.

14. The smart cabinet of claim 1, wherein the inventory scanner is a handheld scanner.

15. The smart cabinet of claim 1, further comprising a pressure sensor within each of the plurality of slots of the drawers, wherein the pressure sensor is configured to track how many slots are occupied.

16. The smart cabinet of claim 1, wherein the cabinet communicates wirelessly with the dispenser.
